(19) United States
(12) Patent Application Publication
(10) Pub. No.: US 2026/0168786 A1
(43) Pub. Date: Jun. 18, 2026

(54) SEMICONDUCTOR MEASURING DEVICE USING POLYCHROMATIC LIGHT AND MONOCHROMATIC LIGHT

(71) Applicant: Samsung Electronics Co., Ltd., Suwon-si (KR)

(72) Inventors: Bumsub Song, Suwon-si (KR); Jinwoo Lee, Suwon-si (KR)

(21) Appl. No.: 19/374,236

(22) Filed: Oct. 30, 2025

(30) Foreign Application Priority Data
Dec. 18, 2024 (KR) 10-2024-0189600

(51) Int. Cl. G01B 11/06; G01B 9/02001; G01B 9/02015

(52) U.S. Cl. CPC G01B 11/0608; G01B 9/02007; G01B 9/02015; G01B 2210/56

(57) ABSTRACT

A semiconductor measuring device includes a first light source that outputs a polychromatic light, a second light source that outputs a monochromatic light, a first beam splitter separates each of the polychromatic light and the monochromatic light toward a measurement target and a reference mirror, a first camera that receives a first interference pattern between a first polychromatic reflected light and a second polychromatic reflected light, a second camera that receives a second interference pattern between a first monochromatic reflected light and a second monochromatic reflected light, and a controller that determines a height value of the measurement target, based on a distance between the first beam splitter and the reference mirror, the first interference pattern, and the second interference pattern.

### CROSS-REFERENCE TO RELATED APPLICATIONS

This application claims priority under 35 U.S.C. § 119 to Korean Patent Application No. 10-2024-0189600 filed on Dec. 18, 2024, in the Korean Intellectual Property Office, the disclosures of which are incorporated by reference herein in their entireties.

### BACKGROUND

Semiconductor measuring devices that irradiate light onto a surface of a manufactured semiconductor wafer, and measure the characteristics of a semiconductor based on the reflected light that is reflected from the surface of the semiconductor wafer may be used in a manufacturing process of semiconductors.

### SUMMARY

The present disclosure relates to a semiconductor measuring device using a polychromatic light and a monochromatic light.

An aspect of the present disclosure provides a semiconductor measuring device that improves a performance of measurement of a height of a measurement target.

A semiconductor measuring device according to an implementation includes a first light source configured to output a polychromatic light; a second light source configured to output a monochromatic light; a first beam splitter configured to separate each of the polychromatic light and the monochromatic light toward a measurement target and a reference mirror; a first camera configured to receive a first interference pattern between a first polychromatic reflected light resulting from a reflection of the polychromatic light off the measurement target and a second polychromatic reflected light resulting from a reflection of the polychromatic light off the reference mirror; a second camera configured to receive a second interference pattern between a first monochromatic reflected light resulting from a reflection of the monochromatic light off the measurement target and a second monochromatic reflected light resulting from a reflection of the monochromatic light off the reference mirror; and a controller configured to determine a height value of the measurement target, based on a distance between the first beam splitter and the reference mirror, the first interference pattern, and the second interference pattern.

A semiconductor measuring device according to an implementation includes a first light source configured to output a polychromatic light; a second light source configured to output a monochromatic light; a first polarizer on an optical path through which the polychromatic light is transmitted, and configured to transmit a first polarization component of the polychromatic light along a specific direction; a second polarizer disposed on an optical path through which the monochromatic light is transmitted, and configured to transmit a second polarization component of the monochromatic light along a direction being perpendicular to the specific direction; a first beam splitter configured to separate each of the polychromatic light and the monochromatic light toward a measurement target and a reference mirror; a first camera configured to receive a first interference pattern between a first polychromatic reflected light resulting from a reflection of the polychromatic light off the measurement target and a second polychromatic reflected light resulting from a reflection of the polychromatic light off the reference mirror; a second camera configured to receive a second interference pattern between a first monochromatic reflected light resulting from a reflection of the monochromatic light off the measurement target and a second monochromatic reflected light resulting from a reflection of the monochromatic light off the reference mirror; and a controller configured to determine a height value of the measurement target, based on the first interference pattern and the second interference pattern.

A semiconductor measuring device according to an implementation includes a first light source configured to output a polychromatic light having a specific wavelength range; a second light source configured to output a monochromatic light having a wavelength deviating from the specific wavelength range by a threshold value or more; a first beam splitter configured to separate each of the polychromatic light and the monochromatic light toward a measurement target and a reference mirror; a first camera configured to receive a first interference pattern between a first polychromatic reflected light resulting from a reflection of the polychromatic light off the measurement target and a second polychromatic reflected light resulting from a reflection of the polychromatic light off the reference mirror; a second camera configured to receive a second interference pattern between a first monochromatic reflected light resulting from a reflection of the monochromatic light off the measurement target and a second monochromatic reflected light resulting from a reflection of the monochromatic light off the reference mirror; and a controller configured to determine a height value of the measurement target, based on a distance between the first beam splitter and the reference mirror, the first interference pattern, and the second interference pattern.

### BRIEF DESCRIPTION OF THE FIGURES

The above and other objects and features of the present disclosure will become apparent by describing in detail implementations thereof with reference to the accompanying drawings.

FIG. 1 is a block diagram illustrating a semiconductor measuring device according to an implementation of the present disclosure;

FIG. 2 is a block diagram illustrating a semiconductor measuring device further including polarizers according to an implementation;

FIG. 3 illustrates a configuration, in which a controller according to an implementation obtains a first height value, based on a first interference pattern;

FIG. 4 illustrates a configuration, in which a controller according to an implementation obtains a second height value, based on a second interference pattern;

FIG. 5 illustrates a configuration in which, a controller according to an implementation obtains a height value of a measurement target, based on a first interference pattern and a second interference pattern;

FIG. 6 is a block diagram illustrating a semiconductor measuring device when a wavelength of a monochromatic light deviates from a wavelength range of a polychromatic light by a threshold value or more according to an implementation;

FIG. 7 is a block diagram illustrating a semiconductor measuring device when a wavelength of a monochromatic light deviates from a wavelength range of a polychromatic light by a threshold value or more according to another implementation;

FIG. 8 is a flowchart illustrating a semiconductor measuring method according to an implementation; and

FIG. 9 is a flowchart illustrating a method of obtaining a height value of a measurement target according to an implementation.

### DETAILED DESCRIPTION

Hereinafter, implementations of the present disclosure will be described in detail and clearly to such an extent that an ordinary one in the art easily implements the present disclosure.

The terms, such as “first”, “second”, and the like used herein can refer to various elements of various implementations of the present disclosure, but do not limit the orders or the importances of the elements.

A semiconductor measuring device may measure height information of a measurement target (e.g., a semiconductor wafer) by using an interference pattern between the reflected light reflected from the measurement target and the reflected light reflected from the reference mirror. When the height information is measured by implementing a white light interferometer (WLI) that utilizes white light that is a polychromatic light, the measurement time can be increased to improve accuracy. On the other hand, when the height information is measured by implementing a phase shifting interferometer (PSI) that uses a monochromatic light, a measurement allowable range can be limited depending on a wavelength of the monochromatic light.

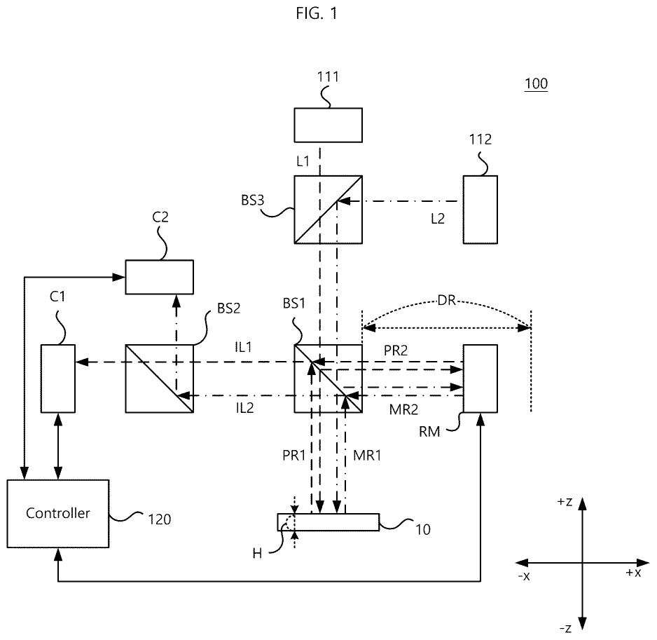

Aspects of the present disclosure may address the above-discusses problems in the related art. FIG. 1 is a block diagram illustrating a semiconductor measuring device according to an implementation of the present disclosure.

Referring to FIG. 1, a semiconductor measuring device 100 according to an implementation can include a first light source 111, a second light source 112, a first beam splitter BS1, a second beam splitter BS2, a third beam splitter BS3, a first camera C1, a second camera C2, and a reference mirror RM. However, the components of the semiconductor measuring device 100 are not limited to the above-described components, and other components (e.g., lenses) can be added or some of the above-described components (e.g., the third beam splitter BS3) can be omitted.

For example, the semiconductor measuring device 100 can further include lenses that are disposed on a path, through which lights are output from the first light source 111 and the second light source 112, respectively. Furthermore, for example, the semiconductor measuring device 100 can further include lenses that are disposed on a path, through which the lights are input to the first camera C1 and the second camera C2, respectively. Furthermore, for example, the semiconductor measuring device 100 can further include a lens that is disposed between the first beam splitter BS1 and a measurement target 10.

The semiconductor measuring device 100 can include a first light source 111 that outputs a polychromatic light L1. More specifically, the semiconductor measuring device 100 can include the first light source 111 that outputs a polychromatic light L1 having a wavelength range (or a distribution). Here, for example, the polychromatic light L1 can be referred to as white light.

For example, the first light source 111 can output the polychromatic light L1 in a direction (e.g., the −z direction) that faces the first beam splitter BS1.

Furthermore, the semiconductor measuring device 100 can include a second light source 112 that outputs a monochromatic light L2. More specifically, the semiconductor measuring device 100 can include the second light source 112 that outputs a monochromatic light L2 having a specified wavelength.

For example, the second light source 112 can output the monochromatic light L2 in a direction (e.g., the −x direction) that faces the third beam splitter BS3.

Here, the third beam splitter BS3 can control the paths of the polychromatic light L1 and the monochromatic light L2, based on the optical characteristics (e.g., polarizations, or wavelengths) of the polychromatic light L1 and the monochromatic light L2.

For example, the third beam splitter BS3 can transmit the polychromatic light L1 and reflect the monochromatic light L2 based on the polarization states of polychromatic light L1 and monochromatic light L2. In some implementations, the third beam splitter BS3 can transmit the polychromatic light L1 and reflect the monochromatic light L2, based on the wavelengths of the polychromatic light L1 and the monochromatic light L2.

Through this, the polychromatic light L1 and the monochromatic light L2 can proceed toward the first beam splitter BS1.

However, the paths of the polychromatic light L1 and the monochromatic light L2 controlled by the third beam splitter BS3, and the optical characteristics for controlling and the paths of the polychromatic light L1 and the monochromatic light L2 by the third beam splitter BS3 are not limited to the above examples.

Furthermore, the semiconductor measuring device 100 can include a first beam splitter BS1 that separates each of the polychromatic light L1 and the monochromatic light L2 toward the measurement target 10 and the reference mirror RM.

More specifically, the first beam splitter BS1 can separate the polychromatic light L1 toward the measurement target 10 and the reference mirror RM. Furthermore, the first beam splitter BS1 can separate the monochromatic light L2 toward the measurement target 10 and the reference mirror RM.

According to an implementation, the first beam splitter BS1 can output a first interference light IL1. The first interference light IL1 can include a first polychromatic reflected light PR1 obtained by reflecting the polychromatic light L1 from the measurement target 10 and a second polychromatic reflected light PR2 obtained by reflecting the polychromatic light L1 from the reference mirror RM.

More specifically, the first beam splitter BS1 can control a path of the first interference light IL1 such that the first interference light IL1 generated by an interference between the first polychromatic reflected light PR1 and the second polychromatic reflected light PR2 is directed to the first camera C1 (and/or the second beam splitter BS2).

Here, the first interference light IL1 can include an interference pattern between the first polychromatic reflected light PR1 and the second polychromatic reflected light PR2.

Furthermore, the first beam splitter BS1 can output a second interference light IL2. The second interference light IL2 can include a first monochromatic reflected light MR1 obtained by reflecting the monochromatic light L2 from the measurement target 10 and a second monochromatic reflected light MR2 obtained by reflecting the monochromatic light L2 from the reference mirror RM.

More specifically, the first beam splitter BS1 can control a path of the second interference light IL2 such that the second interference light IL2 generated by an interference between the first monochromatic reflected light MR1 and the second monochromatic reflected light MR2 is directed to the second beam splitter BS2.

Here, the second interference light IL2 can include an interference pattern between the first monochromatic reflected light MR1 and the second monochromatic reflected light MR2.

The semiconductor measuring device 100 can further include a second beam splitter BS2 that controls the paths of the first interference light IL1 and the second interference light IL2.

According to an implementation, the second beam splitter BS2 can control the paths of the first interference light IL1 and the second interference light IL2, based on the optical characteristics (e.g., polarizations or wavelengths) of the first interference light IL1 and the second interference light IL2.

For example, the second beam splitter BS2 can transmit the first interference light IL1 and reflect the second interference light IL2, based on the polarization states of the first interference light IL1 and the second interference light IL2. In some implementations, the second beam splitter BS2 can transmit the first interference light IL1 and reflect the second interference light IL2, based on the wavelengths of the first interference light IL1 and the second interference light IL2.

Through this, the first interference light IL1 can proceed toward the first camera C1. Furthermore, the second interference light IL2 can proceed toward the second camera C2.

However, the paths of the first interference light IL1 and the second interference light IL2 controlled by the second beam splitter BS2, and the optical characteristics for controlling the paths of the first interference light IL1 and the second interference light IL2, by the second beam splitter BS2, are not limited to the above examples.

Furthermore, the semiconductor measuring device 100 can include a first camera C1 that obtains the first interference light IL1.

More specifically, the first camera C1 can obtain an interference pattern between the first polychromatic reflected light PR1 and the second polychromatic reflected light PR2 from the first interference light IL1.

Furthermore, the semiconductor measuring device 100 can include a second camera C2 that obtains the second interference light IL2.

More specifically, the second camera C2 can obtain an interference pattern between the first monochromatic reflected light MR1 and the second monochromatic reflected light MR2 from the second interference light IL2.

Furthermore, the semiconductor measuring device 100 can include a controller 120 that controls a measurement operation for the measurement target 10 through the semiconductor measuring device 100.

For example, the controller 120 can execute software (or a program) to control at least one other component (e.g., the reference mirror RM) of the semiconductor measuring device 100, and can process and calculate various types of data. The controller 120 can include a central processing device or microprocessor, and can control an overall operation of the semiconductor measuring device 100. Accordingly, it can be understood that the operation performed by the semiconductor measuring device 100 is performed under the control of the controller 120.

According to an implementation, the controller 120 can move the reference mirror RM along a specific direction within a preset distance range DR from the first beam splitter BS1.

For example, the controller 120 can move the reference mirror RM along a first direction (e.g., the +x direction) and/or a second direction (e.g., the −x direction) within the preset distance range DR from the first beam splitter BS1. For example, the controller 120 can reciprocate the reference mirror RM in the first direction (e.g., the +x direction) and the second direction (e.g., the −x direction) within the preset distance range (DR) from the first beam splitter BS1.

In some implementations, the controller 120 can move the reference mirror RM in the first direction (e.g., the +x direction) within the preset distance range DR from the first beam splitter BS1.

Furthermore, the controller 120 can calculate (or obtain) a height value “H” of the measurement target 10, based on the interference pattern obtained through the first camera C1 and/or the second camera C2.

More specifically, the controller 120 can obtain a height value “H” along a third direction (e.g., the +z direction) of the measurement target 10, based on the interference pattern obtained through the first camera C1 and/or the second camera C2.

Here, the height value “H” of the measurement target 10 can be understood as a vertical distance between a point or an area included in one surface that is adjacent to the first beam splitter BS1 and an opposite surface of the measurement target 10.

The controller 120 can obtain the first height value of the measurement target 10, based on the interference pattern between the first polychromatic reflected light PR1 and the second polychromatic reflected light PR2 obtained through the first camera C1.

Here, for example, the controller 120 can obtain the first height value of the measurement target 10, based on the distance between the first beam splitter BS1 and the reference mirror RM at a time point when the interference pattern between the first polychromatic reflected light PR1 and the second polychromatic reflected light PR2 has a maximum value.

Furthermore, the controller 120 can obtain the second height value of the measurement target 10, based on the interference pattern between the first monochromatic reflected light MR1 and the second monochromatic reflected light MR2 obtained through the second camera C2.

Here, for example, the controller 120 can sample data from the interference pattern between the first monochromatic reflected light MR1 and the second monochromatic reflected light MR2 a plurality of times. Furthermore, the controller 120 can obtain the second height value of the measurement target 10 by using the sampled data.

Furthermore, the controller 120 can calculate (or obtain) the height value “H” of the measurement target from the first height value, the second height value, and the wavelength of the monochromatic light L2 by using a preset equation.

For example, the controller 120 can input the wavelength and the second height value of the monochromatic light L2 into a preset equation to obtain the height value “H” of the measurement target 10 having a value within a preset range from the first height value.

Referring to the above-described configurations, the semiconductor measuring device 100 according to an implementation can measure the height of the measurement target 10 by using each of the polychromatic light L1 and the monochromatic light L2.

Furthermore, the semiconductor measuring device 100 can calculate the height value “H” of the measurement target 10 by using different height values that are measured by using each of the polychromatic light L1 and the monochromatic light L2.

Here, the semiconductor measuring device 100 can measure a relatively wide range when measuring the height of the measurement target 10 by using the polychromatic light L1, compared to when measuring by using the monochromatic light L2.

For example, the height (e.g., the first height value) of the measurement target 10 measured through the polychromatic light L1 can be obtained in a relatively wide measurement range, compared to the height (e.g., the second height value) of the measurement target 10 measured through the monochromatic light L2.

Furthermore, the semiconductor measuring device 100 can measure the height of the measurement target 10 with a relatively higher accuracy when it is measured by using the monochromatic light L2, compared with the case, in which is it measured by using the polychromatic light L1.

For example, the height (e.g., the second height value) of the measurement target 10 measured through the monochromatic light L2 can have a relatively high accuracy, compared to the height (e.g., the first height value) of the measurement target 10 measured through the polychromatic light L1.

Accordingly, through the above-described configurations, the semiconductor measuring device 100 according to an implementation of the present disclosure can measure the height value “H” of the measurement target 10 with a relatively high accuracy for a relatively wide range.

For example, the semiconductor measuring device 100 of the present disclosure can improve a performance (e.g., an accuracy or a measurement range) of the height measurement for the measurement target 10.

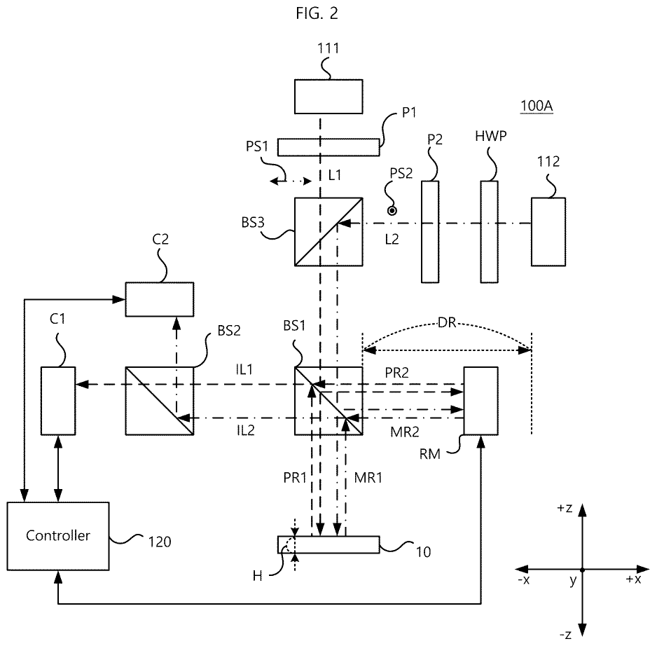

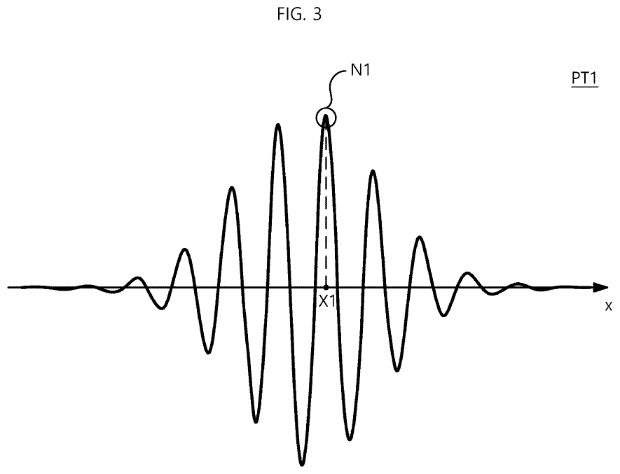

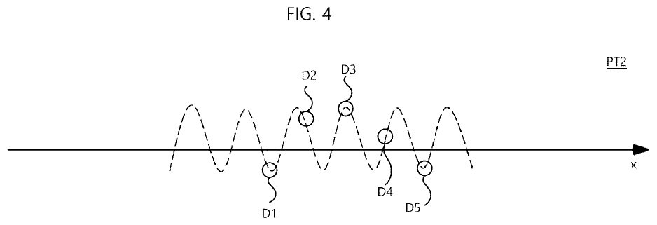

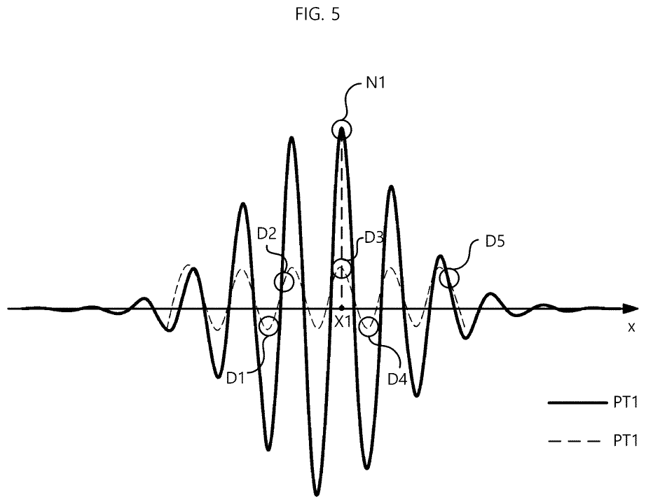

FIG. 2 is a block diagram illustrating a semiconductor measuring device further including polarizers according to an implementation. FIG. 3 illustrates a configuration, in which a controller according to an implementation obtains a first height value, based on a first interference pattern. FIG. 4 illustrates a configuration, in which a controller according to an implementation obtains a second height value, based on a second interference pattern. FIG. 5 illustrates a configuration in which, a controller according to an implementation obtains a height value of a measurement target, based on a first interference pattern and a second interference pattern.

Referring to FIG. 2, a semiconductor measuring device 100A according to an implementation can include a first light source 111, a second light source 112, a first beam splitter BS1, a second beam splitter BS2, a third beam splitter BS3, a first camera C1, a second camera C2, and a reference mirror RM. Furthermore, the semiconductor measuring device 100A can include a first polarizer P1 and a second polarizer P2.

The semiconductor measuring device 100A illustrated in FIG. 2 can be understood as an example of the semiconductor measuring device 100 illustrated in FIG. 1. Accordingly, the same reference numerals are used for components the same or substantially the same as the above-described components, and the same descriptions as the above-described descriptions will be omitted.

The semiconductor measuring device 100A can include a first polarizer P1 that is disposed on an optical path, through which the polychromatic light L1 is output from the first light source 111.

The first polarizer P1 according to an implementation can transmit a first polarization component of the polychromatic light L1 along a specific direction. For example, the first polarizer P1 can transmit a component of the polychromatic light L1 that vibrates in the first direction (e.g. the +x direction) and the second direction (e.g. the −x direction).

For example, the first polarizer P1 can control the polarization state of the polychromatic light L1 output from the first light source 111 to a first polarization state PS1 of vibration in the first direction (e.g. the +x direction) and the second direction (e.g. the −x direction).

Furthermore, the semiconductor measuring device 100A can include a second polarizer P2 that is disposed on an optical path, through which the monochromatic light L2 is output from the second light source 112.

The second polarizer P2 according to an implementation can transmit a second polarization component of the monochromatic light L2 along a direction that is substantially perpendicular to the polarization direction of the polychromatic light L1. For example, the second polarizer P2 can transmit a component of the monochromatic light L2, which vibrates in a fifth direction (e.g., the +y direction) and a sixth direction (e.g., the −y direction).

For example, the second polarizer P2 can control the polarization state of the monochromatic light L2 output from the second light source 112 to a second polarization state PS2 of vibration in the fifth direction (e.g., the +y direction) and the sixth direction (e.g., the −y direction).

Here, the second polarization state PS2 can be understood as being substantially perpendicular to the first polarization state PS1.

Accordingly, the third beam splitter BS3 can receive the polychromatic light L1 and the monochromatic light L2 having polarization states that are perpendicular to each other.

Furthermore, according to an implementation, the third beam splitter BS3 can control the paths of the polychromatic light L1 and the monochromatic light L2, based on the polarization states.

More specifically, the third beam splitter BS3 can transmit the polychromatic light L1 and reflect the monochromatic light L2 based on the polarization states of polychromatic light L1 and monochromatic light L2. Through this, the polychromatic light L1 and the monochromatic light L2 can proceed toward the first beam splitter BS1.

Accordingly, for example, the third beam splitter BS3 can be referred to as a polarizing beam splitter.

Furthermore, the first beam splitter BS1 can separate the polychromatic light L1 toward the measurement target 10 and the reference mirror RM. Furthermore, the first beam splitter BS1 can separate the monochromatic light L2 toward the measurement target 10 and the reference mirror RM.

Here, as the polychromatic light L1 and the monochromatic light L2 have polarization states that are substantially perpendicular to each other, an interference between the polychromatic light L1 and the monochromatic light L2 may not occur.

The first beam splitter BS1 can output a first interference light IL1. The first interference light IL1 can include a first polychromatic reflected light PR1 obtained by reflecting the polychromatic light L1 from the measurement target 10 and a second polychromatic reflected light PR2 obtained by reflecting the polychromatic light L1 from the reference mirror RM.

More specifically, the first beam splitter BS1 can control a path of the first interference light IL1 such that the first interference light IL1 generated by an interference between the first polychromatic reflected light PR1 and the second polychromatic reflected light PR2 is directed to the first camera C1 (or the second beam splitter BS2).

Here, referring to FIGS. 2 and 3 together, the first interference light IL1 can include a first interference pattern PT1 that is generated by an interference between the first polychromatic reflected light PR1 and the second polychromatic reflected light PR2.

Furthermore, the first beam splitter BS1 can output a second interference light IL2. The second interference light IL2 can include a first monochromatic reflected light MR1 obtained by reflecting the monochromatic light L2 from the measurement target 10 and a second monochromatic reflected light MR2 obtained by reflecting the monochromatic light L2 from the reference mirror RM.

More specifically, the first beam splitter BS1 can control a path of the second interference light IL2 such that the second interference light IL2 generated by an interference between the first monochromatic reflected light MR1 and the second monochromatic reflected light MR2 is directed to the second beam splitter BS2.

Here, referring to FIGS. 2 and 4 together, the second interference light IL2 can include a second interference pattern PT2 that is generated by an interference between the first monochromatic reflected light MR1 and the second monochromatic reflected light MR2.

Furthermore, the second beam splitter BS2 according to an implementation can transmit the first interference light IL1 and reflect the second interference light IL2, based on the polarization states of the first interference light IL1 and the second interference light IL2.

Here, the first interference light IL1 can have substantially the same polarization state (e.g., the first polarization state PS1) as that of the polychromatic light L1. Furthermore, the second interference light IL2 can have substantially the same polarization state (e.g., the second polarization state PS2) as that of the monochromatic light L2.

Through this, the first interference light IL1 can proceed toward the first camera C1. Furthermore, the second interference light IL2 can proceed toward the second camera C2.

According to an implementation, the first camera C1 can obtain a first interference pattern PT1 between the first polychromatic reflected light PR1 and the second polychromatic reflected light PR2.

More specifically, the first camera C1 can obtain a first interference pattern PT1 generated by an interference between the first polychromatic reflected light PR1 and the second polychromatic reflected light PR2 from the first interference light IL1.

Furthermore, the second camera C2 can obtain a second interference pattern PT2 between the first monochromatic reflected light MR1 and the second monochromatic reflected light MR2.

More specifically, the second camera C2 can obtain a second interference pattern PT2 generated by an interference between the first monochromatic reflected light MR1 and the second monochromatic reflected light MR2 from the second interference light IL2.

Furthermore, the controller 120 according to an implementation can calculate (or obtain) a height value “H” of the measurement target 10, based on the interference patterns obtained through the first camera C1 and the second camera C2.

More specifically, the controller 120 can obtain the height value “H” of the measurement target 10, based on the first interference pattern PT1 obtained through the first camera C1 and the second interference pattern PT2 obtained through the second camera C2.

Referring to FIGS. 2 and 3 together, the controller 120 can obtain the first height value H1 of the measurement target 10, based on the first interference pattern PT1.

More specifically, the controller 120 can obtain a first height value H1 of the measurement target 10, based on a distance X1 between the first beam splitter BS1 and the reference mirror RM at a point N1, at which the first interference pattern PT1 has a maximum value.

For example, the controller 120 can determine that the first beam splitter BS1 and the measurement target 10 are spaced apart from each other by the distance X1 between the first beam splitter BS1 and the reference mirror RM at the point N1, at which the first interference pattern PT1 has the maximum value.

Furthermore, the controller 120 can calculate the first height value H1 of the measurement target 10, in response to determining that the first beam splitter BS1 and the measurement target 10 are spaced apart from each other by the distance X1 between the first beam splitter BS1 and the reference mirror RM.

Furthermore, referring to FIGS. 2 and 4 together, the controller 120 can obtain the second height value H2 of the measurement target 10, based on the second interference pattern PT2.

More specifically, the controller 120 can sample data for the second interference pattern PT2 a plurality of times. For example, referring to FIG. 4, the controller 120 can sample the first to fifth data D1 to D5 from the second interference pattern PT2.

Furthermore, the controller 120 can obtain the second height value H2 of the measurement target 10 by using the sampled data.

For example, the controller 120 can obtain the second height value H2 by inputting the first to fifth data D1 to D5 to a preset algorithm.

Here, for example, the controller 120 can include distances between the first beam splitter BS1 and the reference mirror RM at time points, when the first to fifth data D1 to D5 are sampled. For example, the controller 120 can input the distances between the first beam splitter BS1 and the reference mirror RM at the time point each of the first to fifth data D1 to D5 is sampled into a preset algorithm.

Here, for example, the preset algorithm can be referred to as a five-stage algorithm for restoration of phases, but the present disclosure is not limited thereto.

According to another implementation, the controller 120 can sample first to third data D1 to D3 from the second interference pattern PT2, and can obtain the second height value H2 by inputting the first to third data D1 to D3 to a phase restoration algorithm.

Furthermore, referring to FIGS. 2 to 5, the controller 120 can calculate (or obtain) the height value “H” of the measurement target 10 from the first height value H1, the second height value H2, and the wavelength of the monochromatic light L2 by using a preset equation.

More specifically, the controller 120 can calculate the height value “H” of the measurement target 10 by inputting the wavelength and the second height value H2 of the monochromatic light L2 into a preset equation. Here, the height value “H” can have a value within a preset range from the first height value H1.

Equations for the controller 120 to obtain the height value “H” can be referenced in Equations 1 and 2 below.

$$H = \frac{λ}{4} \times n \pm H 2 \qquad [ Equation 1 ]$$

$$H 1 - a < H < H 1 + a \qquad [ Equation 2 ]$$

Here, λ can be understood as a wavelength of the monochromatic light L2. Furthermore, “n” can be understood as an arbitrary integer. Furthermore, “a” can be understood as an arbitrary range value according to a range that is set for the first height value H1.

For example, when the wavelength of the monochromatic light L2 is 1000 nm, the first height value H1 is 1250 nm, the second height value H2 is 200 nm, and the preset range value “a” is 70 nm, the controller 120 can determine an arbitrary integer “n” as “4” and obtain the height value “H” of the measurement target 10 of 1200 nm.

For example, the controller 120 can input the wavelength of the monochromatic light L2 and the second height value H2 to a preset equation (e.g., Equation 1) to obtain a height value “H” within a preset range from the first height value H1.

Referring to the above configurations, the polychromatic light L1 and the monochromatic light L2 have polarization states that are substantially perpendicular to each other, and can proceed to measurement target 10 and reference mirror RM, respectively. For example, the polychromatic light L1 and the monochromatic light L2 can be independently separated without interfering with each other and proceed to the measurement target 10 and the reference mirror RM. Furthermore, each of the polychromatic light L1 and the monochromatic light L2 can be reflected from the measurement target 10 and reference mirror RM to generate different interference patterns PT1 and PT2.

For example, the semiconductor measuring device 100A according to an implementation of the present disclosure can obtain different interference patterns PT1 and PT2 for measuring the height value of the measurement target 10 by using each of the polychromatic light L1 and the monochromatic light L2 that do not interfere with each other.

Furthermore, the semiconductor measuring device 100A can obtain the height value “H” of the measurement target 10 by using different interference patterns PT1 and PT2 obtained by using the polychromatic light L1 and the monochromatic light L2, respectively.

Here, the semiconductor measuring device 100A can measure a relatively wide range when measuring the height of the measurement target 10 by using the polychromatic light L1, compared to when measuring by using the monochromatic light L2.

For example, the height (e.g., the first height value) of the measurement target 10 measured through the polychromatic light L1 can be obtained in a relatively wide measurement range, compared to the height (e.g., the second height value) of the measurement target 10 measured through the monochromatic light L2.

Furthermore, the semiconductor measuring device 100A can measure the height of the measurement target 10 with a relatively higher accuracy when it is measured by using the monochromatic light L2, compared with the case, in which is it measured by using the polychromatic light L1.

For example, the height (e.g., the second height value) of the measurement target 10 measured through the monochromatic light L2 can have a relatively high accuracy, compared to the height (e.g., the first height value) of the measurement target 10 measured through the polychromatic light L1.

Accordingly, through the above-described configurations, the semiconductor measuring device 100A according to an implementation of the present disclosure can measure the height value “H” of the measurement target 10 with a relatively high accuracy for a relatively wide range.

For example, the semiconductor measuring device 100A of the present disclosure can improve a performance (e.g., an accuracy or a measurement range) of the height measurement for the measurement target 10.

Furthermore, the semiconductor measuring device 100A can include a half-wave plate HWP that is disposed between the second polarizer P2 and the second light source 112.

More specifically, the half-wave plate HWP can rotate a polarization axis (or a polarization direction) of the monochromatic light L2 output from the second light source 112 by a specific angle. For example, the half-wave plate HWP can rotate the polarization axis of the monochromatic light L2 by an angle corresponding to half the wavelength of the monochromatic light L2.

Referring to the above-described configurations, the monochromatic light L2 according to an implementation can proceed toward the second polarizer P2 in a state, in which the polarization direction is changed by the half-wave plate HWP.

Through this, the semiconductor measuring device 100A according to an implementation of the present disclosure can minimize an amount of decrease in an intensity (or an energy) of the monochromatic light L2 by controlling the monochromatic light L2 to a specific polarization state.

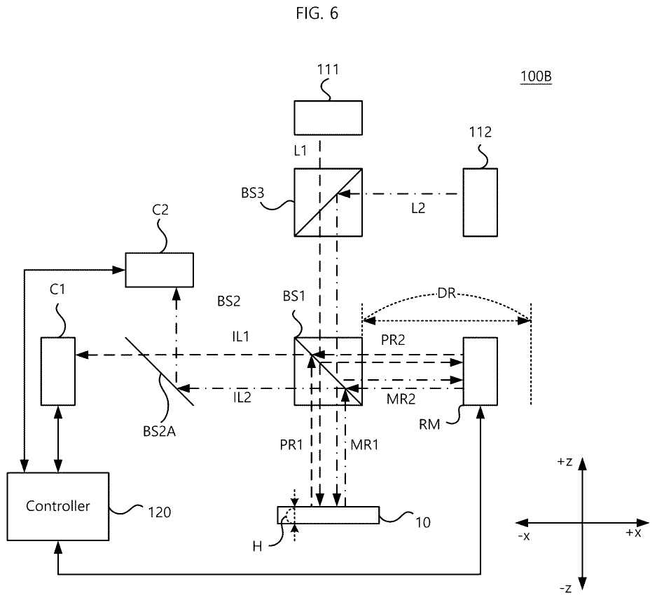

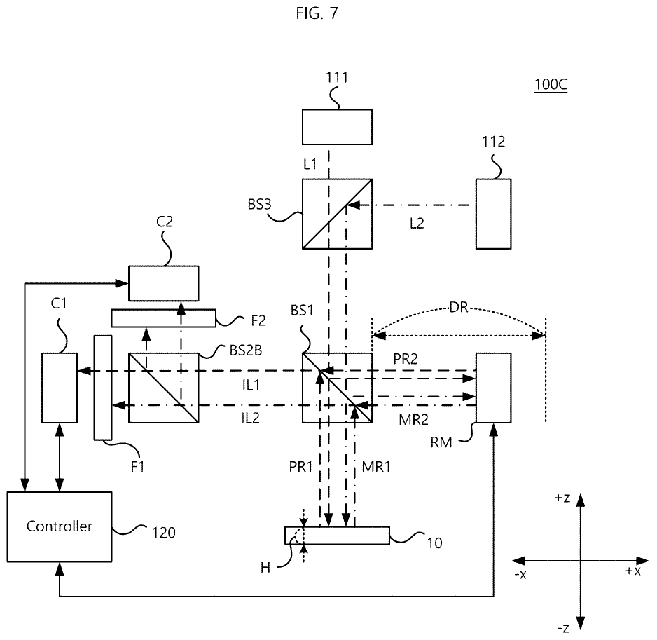

FIG. 6 is a block diagram illustrating a semiconductor measuring device when a wavelength of a monochromatic light deviates from a wavelength range of a polychromatic light by a threshold value or more according to an implementation. FIG. 7 is a block diagram illustrating a semiconductor measuring device when a wavelength of a monochromatic light deviates from a wavelength range of a polychromatic light by a threshold value or more according to another implementation.

Referring to FIG. 6, a semiconductor measuring device 100B according to an implementation can include a first light source 111, a second light source 112, a first beam splitter BS1, a second beam splitter BS2A, a third beam splitter BS3, a first camera C1, a second camera C2, and a reference mirror RM.

The semiconductor measuring device 100B illustrated in FIG. 6 can be understood as an example of the semiconductor measuring device 100 illustrated in FIG. 1. Accordingly, the same reference numerals are used for components the same or substantially the same as the above-described components, and the same descriptions as the above-described descriptions will be omitted.

According to an implementation, the semiconductor measuring device 100B can include a second beam splitter BS2A that separates the first interference light IL1 and the second interference light IL2 to a first camera C1 and a second camera C2, based on respective wavelengths.

More specifically, the semiconductor measuring device 100B can include a second beam splitter BS2A that separates the first interference light IL1 and the second interference light IL2 based on respective wavelengths when the wavelength of the monochromatic light L2 deviates from the wavelength range of the polychromatic light L1 by a preset threshold value or more.

According to an implementation, when the wavelength of the monochromatic light L2 deviates from the wavelength range of the polychromatic light L1 by a preset threshold value or more, the polychromatic light L1 and the monochromatic light L2 can proceed independently without interfering with each other.

The second beam splitter BS2A according to an implementation can selectively transmit or reflect light depending on a wavelength of the input light. Accordingly, for example, the second beam splitter BS2A can be referred to as a dichroic mirror.

Furthermore, here, the first interference light IL1 can have substantially the same wavelength range as that of the polychromatic light L1. Furthermore, the second interference light IL2 can have substantially the same wavelength as that of the monochromatic light L2. Accordingly, the first interference light IL1 and the second interference light IL2 may not interfere with each other.

The second beam splitter BS2A can transmit the first interference light IL1, based on the wavelength of the first interference light IL1. Through this, the first interference light IL1 can proceed toward the first camera C1.

Furthermore, the second beam splitter BS2A can reflect the second interference light IL2, based on the wavelength of the second interference light IL2. Through this, the second interference light IL2 can proceed toward the second camera C2.

Referring to FIG. 7 according to another implementation, the semiconductor measuring device 100C can include a first light source 111, a second light source 112, a first beam splitter BS1, a second beam splitter BS2B, a third beam splitter BS3, a first camera C1, a second camera C2, a first optical filter F1, a second optical filter F2, and a reference mirror RM.

The semiconductor measuring device 100C illustrated in FIG. 7 can be understood as an example of the semiconductor measuring device 100 illustrated in FIG. 1. Furthermore, the semiconductor measuring device 100C illustrated in FIG. 7 can be understood as having substantially the same configuration as that of the semiconductor measuring device 100B illustrated in FIG. 6, except for the first optical filter F1, the second optical filter F2, and the second beam splitter BS2B.

Accordingly, the same reference numerals are used for components the same or substantially the same as the above-described components, and the same descriptions as the above-described descriptions will be omitted.

According to an implementation, the semiconductor measuring device 100C can include a second beam splitter BS2B that separates each of the first interference light IL1 and the second interference light IL2 to a first camera C1 and a second camera C2.

More specifically, the semiconductor measuring device 100C can include a second beam splitter BS2A that separates each of the first interference light IL1 and the second interference light IL2 to the first camera C1 and the second camera C2 when the wavelength of the monochromatic light L2 deviates from the wavelength range of the polychromatic light L1 by a preset threshold value or more.

Furthermore, the semiconductor measuring device 100C can include a first optical filter F1 that is disposed between the second beam splitter BS2B and the first camera C1.

The first optical filter F1 according to an implementation can transmit the first interference light IL1. More specifically, the first optical filter F1 can transmit the first interference light IL1, among the first interference light IL1 and the second interference light IL2, based on the wavelengths of the first interference light IL1 and the second interference light IL2.

Furthermore, the semiconductor measuring device 100C can include a second optical filter F2 that is disposed between the second beam splitter BS2B and the second camera C2.

The second optical filter F2 according to an implementation can transmit the second interference light IL2. More specifically, the second optical filter F2 can transmit the second interference light IL2, among the first interference light IL1 and the second interference light IL2, based on the wavelengths of the first interference light IL1 and the second interference light IL2.

For example, when the wavelength of the monochromatic light L2 deviates from the wavelength range of the polychromatic light L1 by a threshold value or more, the semiconductor measuring device 100B and 100C can separate the first interference light IL1 and the second interference light IL2 to different cameras C1 and C2 based on the wavelengths thereof.

Furthermore, the first camera C1 can obtain a first interference pattern PT1 generated by an interference between the first polychromatic reflected light PR1 and the second polychromatic reflected light PR2 from the first interference light IL1.

Furthermore, the second camera C2 can obtain a second interference pattern PT2 generated by an interference between the first monochromatic reflected light MR1 and the second monochromatic reflected light MR2 from the second interference light IL2.

Furthermore, the controller 120 can calculate (or obtain) a height value “H” of the measurement target 10, based on the interference patterns obtained through the first camera C1 and the second camera C2.

The controller 120 can obtain the first height value H1 of the measurement target 10, based on the first interference pattern PT1.

More specifically, the controller 120 can obtain a first height value H1 of the measurement target 10, based on a distance X1 between the first beam splitter BS1 and the reference mirror RM at a point N1, at which the first interference pattern PT1 has a maximum value.

Furthermore, the controller 120 can obtain the second height value H2 of the measurement target 10, based on the second interference pattern PT2.

More specifically, the controller 120 can sample data for the second interference pattern PT2 a plurality of times. Furthermore, the controller 120 can obtain the second height value H2 of the measurement target 10 by using the sampled data.

Furthermore, the controller 120 can calculate (or obtain) the height value “H” of the measurement target, based on the first height value H1, the second height value H2, and the wavelength of the monochromatic light L2.

More specifically, the controller 120 can calculate the height value “H” of the measurement target 10 by inputting the wavelength and the second height value H2 of the monochromatic light L2 into a preset equation. Here, the height value “H” can have a value within a preset range from the first height value H1.

Referring to the above-described configurations, the polychromatic light L1 and the monochromatic light L2 can be separated to the measurement target 10 and the reference mirror RM, respectively. Here, when the wavelength of the monochromatic light L2 deviates from the wavelength range of the polychromatic light L1 by a preset threshold value or more, the polychromatic light L1 and the monochromatic light L2 can be separated independently and proceed to the measurement target 10 and the reference mirror RM without interfering with each other. Furthermore, each of the polychromatic light L1 and the monochromatic light L2 can be reflected from the measurement target 10 and reference mirror RM to generate different interference patterns PT1 and PT2.

Furthermore, the semiconductor measuring device 100B and 100C can obtain different interference patterns PT1 and PT2 from each of the first interference light IL1 obtained through the polychromatic light L1 and the second interference light IL2 obtained through the monochromatic light L2. Here, the semiconductor measuring devices 100B and 100C can obtain different interference patterns PT1 and PT2 by separating the first interference light IL1 and the second interference light IL2 based on the wavelengths thereof.

Furthermore, the semiconductor measuring devices 100B and 100C can obtain the height value “H” of the measurement target 10 by using different interference patterns PT1 and PT2.

Here, the semiconductor measuring device 100B and 100C can measure a relatively wide range when measuring the height of the measurement target 10 by using the polychromatic light L1, compared to when measuring by using the monochromatic light L2.

For example, the height (e.g., the first height value) of the measurement target 10 measured through the polychromatic light L1 can be obtained in a relatively wide measurement range, compared to the height (e.g., the second height value) of the measurement target 10 measured through the monochromatic light L2.

Furthermore, the semiconductor measuring device 100B and 100C can measure the height of the measurement target 10 with a relatively higher accuracy when it is measured by using the monochromatic light L2, compared with the case, in which is it measured by using the polychromatic light L1.

For example, the height (e.g., the second height value) of the measurement target 10 measured through the monochromatic light L2 can have a relatively high accuracy, compared to the height (e.g., the first height value) of the measurement target 10 measured through the polychromatic light L1.

Accordingly, through the above-described configurations, the semiconductor measuring device 100B and 100C according to an implementation of the present disclosure can measure the height value “H” of the measurement target 10 with a relatively high accuracy for a relatively wide range.

For example, the semiconductor measuring device 100B and 100C of the present disclosure can improve a performance (e.g., an accuracy or a measurement range) of the height measurement for the measurement target 10.

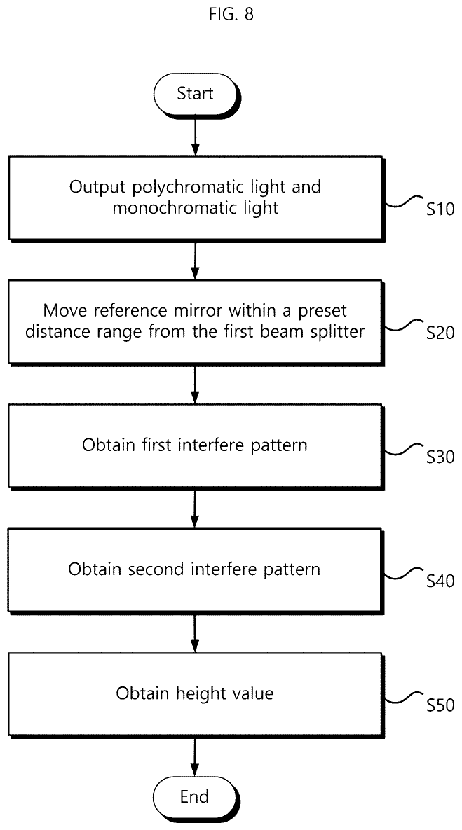

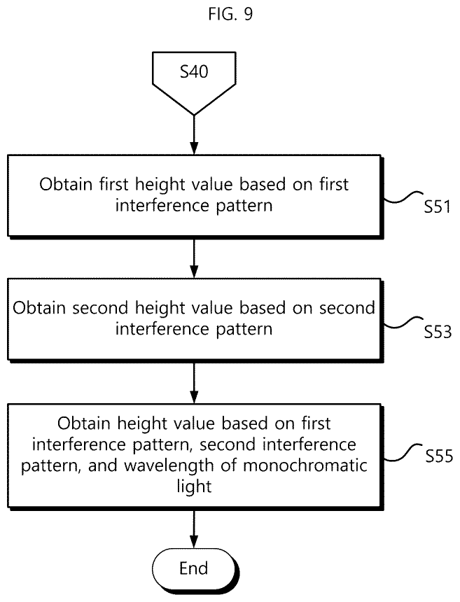

FIG. 8 is a flowchart illustrating a semiconductor measuring method according to an implementation. FIG. 9 is a flowchart illustrating a method of obtaining a height value of a measurement target according to an implementation.

Referring to FIGS. 8 and 9 together, the semiconductor measuring device 100 according to an implementation can obtain a height value of the measurement target 10, based on different interference patterns PT1 and PT2 obtained by using each of the polychromatic light L1 and the monochromatic light L2.

In operation S10, the semiconductor measuring device 100 according to an implementation can output the polychromatic light L1 through the first light source 111 and can output the monochromatic light L2 through the second light source 112.

More specifically, the semiconductor measuring device 100 can output the polychromatic light L1 (e.g., white light) toward the first beam splitter BS1 (or the third beam splitter BS3) through the first light source 111. Furthermore, the semiconductor measuring device 100 can output the monochromatic light L2 toward the third beam splitter BS3 (or the first beam splitter BS1) through the second light source 112.

In operation S20, the semiconductor measuring device 100 according to an implementation can move the reference mirror RM within a preset distance range DR from the first beam splitter BS1.

More specifically, the semiconductor measuring device 100 can move the reference mirror RM along a specific direction within a preset distance range DR from the first beam splitter BS1. Here, the first beam splitter BS1 can separate each of the polychromatic light L1 and the monochromatic light L2 to a measurement target 10 and a reference mirror RM.

However, according to another implementation, the semiconductor measuring device 100 can reciprocate the reference mirror RM from the first beam splitter BS1 along a specific direction within a preset distance range DR.

In operation S30, the semiconductor measuring device 100 according to an implementation can obtain the first interference pattern PT1.

More specifically, the semiconductor measuring device 100 can obtain the first interference pattern PT1 between the first polychromatic reflected light PR1 obtained by reflecting the polychromatic light L1 from the measurement target 10 and the second polychromatic reflected light PR2 obtained by reflecting the polychromatic light L1 from the reference mirror RM.

For example, the semiconductor measuring device 100 can obtain a first interference light IL1 including the first interference pattern PT1 between the first polychromatic reflected light PR1 and the second polychromatic reflected light PR2, by using the first camera C1.

In operation S40, the semiconductor measuring device 100 according to an implementation can obtain the second interference pattern PT2.

More specifically, the second interference pattern PT2 between the first monochromatic reflected light MR1 obtained by reflecting the monochromatic light L2 from the measurement target 10 and the second monochromatic reflected light MR2 obtained by reflecting the monochromatic light L2 from the reference mirror RM can be obtained.

For example, the semiconductor measuring device 100 can obtain a second interference light IL2 including the second interference pattern PT2 between the first monochromatic reflected light MR1 and the second monochromatic reflected light MR2 by using the second camera C2.

However, the order, in which operation S30 and operation S40 are performed is not limited to the illustration of FIG. 8. In some implementations, at least some of operation S30 and operation S40 can be performed simultaneously.

In operation S50, the semiconductor measuring device 100 according to an implementation can obtain the height value “H” of the measurement target 10.

The semiconductor measuring device 100 can obtain the height value “H” of the measurement target 10, based on the distance between the first beam splitter BS1 and the reference mirror RM, the first interference pattern PT1, and the second interference pattern PT2.

More specifically, referring to FIGS. 8 and 9 together, the semiconductor measuring device 100 according to an implementation can obtain the height value “H” of the measurement target 10, based on the first height value H1 obtained from the first interference pattern PT1 and the second height value H2 obtained from the second interference pattern PT2.

In operation S51, the semiconductor measuring device 100 according to an implementation can obtain the first height value H1, based on the first interference pattern PT1.

More specifically, the semiconductor measuring device 100 can obtain a first height value H1 of the measurement target 10, based on a distance between the first beam splitter BS1 and the reference mirror RM at a point (or a time point), at which the first interference pattern PT1 has a maximum value.

For example, the semiconductor measuring device 100 can determine that the first beam splitter BS1 and the measurement target 10 are spaced apart from each other by the distance between the first beam splitter BS1 and the reference mirror RM at the point (time point), at which the first interference pattern PT1 has the maximum value.

Furthermore, the semiconductor measuring device 100 can calculate the first height value H1 of the measurement target 10, based on that the first beam splitter BS1 and the measurement target 10 are spaced apart from each other by the distance between the first beam splitter BS1 and the reference mirror RM.

In operation S53, the semiconductor measuring device 100 according to an implementation can obtain the second height value H2, based on the second interference pattern PT2.

More specifically, the semiconductor measuring device 100 can sample data for the second interference pattern PT2 a plurality of times. Furthermore, the semiconductor measuring device 100 can obtain the second height value H2 of the measurement target 10 by using the sampled data.

For example, the semiconductor measuring device 100 can obtain a second height value H2 by inputting sampled data (e.g., distance values between the first beam splitter BS1 and the reference mirror RM at the time points of sampling) into a preset algorithm.

In operation S55, the semiconductor measuring device 100 according to an implementation can calculate (or obtain) the height value “H” of the measurement target 10, based on the first height value H1, the second height value H2, and the wavelength of the monochromatic light L2.

More specifically, the semiconductor measuring device 100 can calculate the height value “H” of the measurement target 10 by inputting the wavelength and the second height value H2 of the monochromatic light L2 into a preset equation. Here, the height value “H” can have a value within a preset range from the first height value H1.

For example, semiconductor measuring device 100 can input the wavelength of the monochromatic light L2 and the second height value H2 to a preset equation to obtain a height value “H” within a preset range from the first height value H1.

Referring to the above-described configurations, the polychromatic light L1 and the monochromatic light L2 can proceed to the measurement target 10 and the reference mirror RM, respectively.

Here, the polychromatic light L1 and the monochromatic light L2 according to an implementation can have polarization states that are substantially perpendicular to each other. According to another implementation, the wavelength of the monochromatic light L2 can have a value that deviates from the wavelength range of the polychromatic light L1 by a threshold value or more.

For example, the polychromatic light L1 and the monochromatic light L2 can independently proceed to the measurement target 10 and the reference mirror RM without interfering with each other. Furthermore, each of the polychromatic light L1 and the monochromatic light L2 can be reflected from the measurement target 10 and reference mirror RM to generate different interference patterns PT1 and PT2.

For example, the semiconductor measuring device 100 according to an implementation of the present disclosure can obtain different interference patterns PT1 and PT2 for measuring the height value of the measurement target 10 by using each of the polychromatic light L1 and the monochromatic light L2 that do not interfere with each other.

Furthermore, the semiconductor measuring device 100 can obtain the height value “H” of the measurement target 10 by using different interference patterns PT1 and PT2 obtained by using the polychromatic light L1 and the monochromatic light L2, respectively.

Here, the semiconductor measuring device 100 can measure a relatively wide range when measuring the height of the measurement target 10 by using the polychromatic light L1, compared to when measuring by using the monochromatic light L2.

For example, the height (e.g., the first height value) of the measurement target 10 measured through the polychromatic light L1 can be obtained in a relatively wide measurement range, compared to the height (e.g., the second height value) of the measurement target 10 measured through the monochromatic light L2.

Furthermore, the semiconductor measuring device 100 can measure the height of the measurement target 10 with a relatively higher accuracy when it is measured by using the monochromatic light L2, compared with the case, in which is it measured by using the polychromatic light L1.

For example, the height (e.g., the second height value) of the measurement target 10 measured through the monochromatic light L2 can have a relatively high accuracy, compared to the height (e.g., the first height value) of the measurement target 10 measured through the polychromatic light L1.

Accordingly, through the above-described configurations, the semiconductor measuring device 100 according to an implementation of the present disclosure can measure the height value “H” of the measurement target 10 with a relatively high accuracy for a relatively wide range.

For example, the semiconductor measuring device 100 of the present disclosure can improve a performance (e.g., an accuracy or a measurement range) of the height measurement for the measurement target 10.

As described above, the semiconductor measuring device 100 according to an implementation of the present disclosure can obtain different interference patterns PT1 and PT2 for measuring the height value of the measurement target 10 by using each of the polychromatic light L1 and the monochromatic light L2 that do not interfere with each other.

Furthermore, the semiconductor measuring device 100 can obtain the height value “H” of the measurement target 10 by using different interference patterns PT1 and PT2 obtained by using the polychromatic light L1 and the monochromatic light L2, respectively.

Here, the semiconductor measuring device 100 can measure a relatively wide range when measuring the height of the measurement target 10 by using the polychromatic light L1, compared to when measuring by using the monochromatic light L2.

Furthermore, the semiconductor measuring device 100 can measure the height of the measurement target 10 with a relatively higher accuracy when it is measured by using the monochromatic light L2, compared with the case, in which it is measured by using the polychromatic light L1.

Accordingly, through the above-described configurations, the semiconductor measuring device 100 according to an implementation of the present disclosure can measure the height value “H” of the measurement target 10 with a relatively high accuracy for a relatively wide range.

For example, the semiconductor measuring device 100 of the present disclosure can improve a performance (e.g., an accuracy or a measurement range) of the height measurement for the measurement target 10.

The semiconductor measuring device according to an implementation of the present disclosure can improve the performance of the measurement of the height of the measurement target.

As used herein, “about,” “approximately,” “generally,” and “substantially” are understood to refer to numbers in a range of numerals, for example the range of −10% to +10% of the referenced number, preferably-5% to +5% of the referenced number, more preferably-1% to +1% of the referenced number, most preferably-0.1% to +0.1% of the referenced number. Moreover, any numerical ranges disclosed herein should be interpreted as providing support for any specific value or sub-range within the stated range. For example, a disclosure of a range from 1 to 10 supports sub-ranges such as 1 to 5, 3 to 6, 1 to 9, 2.5 to 4.7, 2.2 to 9.9, and so on.

While the present disclosure contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Implementations in which a design is changed simply or which are easily changed can be included in the present disclosure as well as an implementation described above. In addition, technologies that are easily changed and implemented by using the above implementations can be included in the present disclosure. While the present disclosure has been described with reference to implementations described above, it will be apparent to those of ordinary skill in the art that various changes and modifications can be made thereto without departing from the spirit and scope of the present disclosure as set forth in the following claims.

What is claimed is:

1. A semiconductor measuring device comprising:
a first light source configured to output a polychromatic light;
a second light source configured to output a monochromatic light;
a first beam splitter configured to separate each of the polychromatic light and the monochromatic light toward a measurement target and a reference mirror;
a first camera configured to receive a first interference pattern between a first polychromatic reflected light resulting from a reflection of the polychromatic light off the measurement target and a second polychromatic reflected light resulting from a reflection of the polychromatic light off the reference mirror;
a second camera configured to receive a second interference pattern between a first monochromatic reflected light resulting from a reflection of the monochromatic light off the measurement target and a second monochromatic reflected light resulting from a reflection of the monochromatic light off the reference mirror; and
a controller configured to determine a height value of the measurement target, based on a distance between the first beam splitter and the reference mirror, the first interference pattern, and the second interference pattern.

2. The semiconductor measuring device of claim 1, wherein the controller is configured to:
move the reference mirror along a specific direction within a preset distance range from the first beam splitter; and
determine a first height value of the measurement target, based on the distance between the reference mirror and the first beam splitter at a time point, at which the first interference pattern has a maximum value.

3. The semiconductor measuring device of claim 2, wherein the controller is configured to:
sample data from the second interference pattern a plurality of times; and
determine a second height value of the measurement target, based on the sampled data.

4. The semiconductor measuring device of claim 3, wherein the controller is configured to determine the height value based on a wavelength of the monochromatic light and the second height value, by using a preset formula, wherein the height value is within a preset range from the first height value.

5. The semiconductor measuring device of claim 1, comprising:
a second beam splitter on a first optical path between the first beam splitter and the first camera, and a second optical path between the first beam splitter and the second camera,
wherein the first beam splitter is configured to output:
a first interference light generated through an interference between the first polychromatic reflected light and the second polychromatic reflected light, and
a second interference light generated through an interference between the first monochromatic reflected light and the second monochromatic reflected light, and
wherein the second beam splitter is configured to control paths of the first interference light and the second interference light such that the first interference light proceeds to the first camera and the second interference light proceeds to the second camera.

6. The semiconductor measuring device of claim 5, wherein the second beam splitter is configured to separate the first interference light and the second interference light based on a polarization state.

7. The semiconductor measuring device of claim 5, wherein the second beam splitter is configured to separate the first interference light and the second interference light based on wavelengths of the first interference light and the second interference light, based on a wavelength of the monochromatic light deviating from a range of a wavelength of the polychromatic light by a preset threshold value or more.

8. The semiconductor measuring device of claim 5, comprising:
a first polarizer on an optical path through which the polychromatic light is transmitted, and configured to control a polarization state of the polychromatic light to a first polarization state; and
a second polarizer on an optical path through which the monochromatic light is transmitted, and configured to control a polarization state of the monochromatic light to a second polarization state being perpendicular to the first polarization state.

9. The semiconductor measuring device of claim 8, comprising:
a half-wave plate between the second light source and the second polarizer,
wherein the half-wave plate is configured to rotate a polarization axis of the monochromatic light by a specific angle.

10. The semiconductor measuring device of claim 8, comprising:
a third beam splitter configured to control an optical path of at least one of the polychromatic light or the monochromatic light such that the at least one of the polychromatic light or the monochromatic light proceeds toward the first beam splitter.

11. The semiconductor measuring device of claim 10, wherein, based on the polarization states of the polychromatic light and the monochromatic light, the third beam splitter is configured to:
transmit the polychromatic light having the first polarization state; and
refract the monochromatic light having the second polarization state.

12. A semiconductor measuring device comprising:
a first light source configured to output a polychromatic light;
a second light source configured to output a monochromatic light;
a first polarizer on an optical path through which the polychromatic light is transmitted, and configured to transmit a first polarization component of the polychromatic light along a specific direction;
a second polarizer disposed on an optical path through which the monochromatic light is transmitted, and configured to transmit a second polarization component of the monochromatic light along a direction being perpendicular to the specific direction;
a first beam splitter configured to separate each of the polychromatic light and the monochromatic light toward a measurement target and a reference mirror;
a first camera configured to receive a first interference pattern between a first polychromatic reflected light resulting from a reflection of the polychromatic light off the measurement target and a second polychromatic reflected light resulting from a reflection of the polychromatic light off the reference mirror;
a second camera configured to receive a second interference pattern between a first monochromatic reflected light resulting from a reflection of the monochromatic light off the measurement target and a second monochromatic reflected light resulting from a reflection of the monochromatic light off the reference mirror; and
a controller configured to determine a height value of the measurement target, based on the first interference pattern and the second interference pattern.

13. The semiconductor measuring device of claim 12, wherein the controller is configured to:
move the reference mirror in a specific direction within a preset distance range from the first beam splitter;
determine a first height value of the measurement target, based on the first interference pattern;
determine a second height value of the measurement target, based on the second interference pattern; and
determine the height value of the measurement target based on the first height value, a wavelength of the monochromatic light, and the second height value, by using a preset formula, wherein the height value of the measurement target is within a preset range.

14. The semiconductor measuring device of claim 13, wherein the controller is configured to determine the first height value, based on a distance between the reference mirror and the first beam splitter at a time point, at which the first interference pattern has a maximum value.

15. The semiconductor measuring device of claim 13, wherein the controller is configured to:
sample data from the second interference pattern a plurality of times; and
determine the second height value, based on the sampled data.

16. The semiconductor measuring device of claim 12, comprising:
a second beam splitter on a first optical path between the first beam splitter and the first camera and a second optical path between the first beam splitter and the second camera,
wherein the first beam splitter is configured to output:
a first interference light generated through an interference between the first polychromatic reflected light and the second polychromatic reflected light, and
a second interference light generated through an interference between the first monochromatic reflected light and the second monochromatic reflected light, and
wherein the second beam splitter is configured to separate the first interference light and the second interference light output from the first beam splitter toward the first camera and the second camera.

17. A semiconductor measuring device comprising:
a first light source configured to output a polychromatic light having a wavelength range;
a second light source configured to output a monochromatic light having a wavelength deviating from the wavelength range by a threshold value or more;
a first beam splitter configured to separate each of the polychromatic light and the monochromatic light toward a measurement target and a reference mirror;
a first camera configured to receive a first interference pattern between a first polychromatic reflected light resulting from a reflection of the polychromatic light off the measurement target and a second polychromatic reflected light resulting from a reflection of the polychromatic light off the reference mirror;
a second camera configured to receive a second interference pattern between a first monochromatic reflected light resulting from a reflection of the monochromatic light off the measurement target and a second monochromatic reflected light resulting from a reflection of the monochromatic light off the reference mirror; and
a controller configured to determine a height value of the measurement target, based on a distance between the first beam splitter and the reference mirror, the first interference pattern, and the second interference pattern.

18. The semiconductor measuring device of claim 17, comprising:
a second beam splitter on a first optical path between the first beam splitter and the first camera and a second optical path between the first beam splitter and the second camera; and
a third beam splitter configured to reflect at least a portion of the polychromatic light and the monochromatic light such that the polychromatic light and the monochromatic light are directed to the first beam splitter,
wherein the first beam splitter is configured to output:
a first interference light generated through an interference between the first polychromatic reflected light and the second polychromatic reflected light, and
a second interference light generated through an interference between the first monochromatic reflected light and the second monochromatic reflected light.

19. The semiconductor measuring device of claim 18, wherein, based on wavelengths of the first interference light and the second interference light, the second beam splitter is configured to:
transmit the first interference light such that the first interference light proceeds to the first camera; and
reflect the second interference light such that the second interference light proceeds to the second camera.

20. The semiconductor measuring device of claim 18, comprising:
a first optical filter between the second beam splitter and the first camera and configured to transmit the first interference light; and
a second optical filter between the second beam splitter and the second camera and configured to transmit the second interference light,
wherein the second beam splitter is configured to separate each of the first interference light and the second interference light toward the first camera and the second camera.
